(19) United States
(12) Patent Application Publication
(10) Pub. No.: US 2006/0213886 A1
(43) Pub. Date: Sep. 28, 2006

(54) Marking method and market object

(76) Inventors: Renatus Hendricus Maria Sanders, EINDHOVEN (NL); Erik-Kees Engels, Eindhoven (NL); Willem Hoving, Eindhoven (NL); Henk Kole, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/548,719

(22) PCT Filed: Mar. 11, 2004
(86) PCT No.: PCT/IB04/50230

§ 371 Date: Sep. 8, 2005

(30) Foreign Application Priority Data
Mar. 13, 2003 (EP) 03100637.2

(51) Int. Cl. B23K 26/00

(52) U.S. Cl. 219/121.85; 427/596

(57) ABSTRACT

Disclosed is a method of marking an object by means of a laser beam. Said method comprising the steps of: applying a donor film on a support, said support at least partly being transparent to the laser beam; placing the support with the donor film in proximity to the surface to be patterned, such that the donor film faces the object to be marked; irradiating the donor film with the laser beam through the support, thereby transcribing a pattern of the donor film to the object; and removing the support with the donor film from the object. The donor film has a thickness of at least 0.5 micron. Also disclosed is a marked object that is obtained by means of the above method, wherein the marking has a thickness of at least 0.5 micron.

The present invention relates to a method of marking an object by means of a laser beam, said method comprising the steps of:

applying a donor film on a support, said support at least partly being transparent to the laser beam;

placing the support with the donor film in proximity to the surface to be patterned, such that the donor film faces the object to be marked;

irradiating the donor film with the laser beam through the support, thereby transcribing a pattern of the donor film to the object; and

removing the support with the donor film from the object.

Furthermore, the present invention relates to a marked object that is obtainable by means of the above method.

The above method is also known as the LIFT (Laser Induced Forward Transfer) method. In said method a thin donor film is coated onto a support that is transparent at the wavelength of the laser. The film is placed in close proximity to the surface to be patterned. The laser pulse melts and partly evaporates the film. The evaporation pressure propels the molten film towards the target. The printed pattern consists of resolidified droplets and condensed vapor.

The above method is suitably used for marking objects made, e.g., from glass, plastics or the like with characters, numerals, signs, codes, figures or any other identification information. Said objects may, for example, comprise a liquid crystal display panel, a plasma display panel or a cathode ray tube or constituents thereof.

When using Laser Induced Forward Transfer to mark a glass substrate, there is a risk of damaging the glass e.g. by introducing (micro-) cracks. Such cracks of course have to be avoided, especially in the case of marking CRTs where the mechanical properties of the glass are very important.

The LIFT method is known from EP-A-0 850 779, which is incorporated herein by reference. According to said patent application it is important that a gap is maintained between the donor film and the surface of the object to be marked during the marking process. The gap should not be too narrow in order to prevent the support and the object to be marked from being welded together. When the gap is too narrow, the donor film that is heated by the laser beam may cause this effect. According to EP-A-0 850 779 the thickness of the donor film is in the range of 100-330 nm. On the other hand, the gap should not be too wide, as this may cause a blurred pattern on the surface of the object to be marked.

It will be clear that the necessity of accurate control of the distance between the donor film and the object to be marked is a disadvantage of the method according to EP-A-0 850 779.

Therefore, it is an object of the present invention to provide a method that does not have the above disadvantage. Moreover, it is an aim to provide such a method while the risk of damaging the object to be marked is reduced.

To this end, the present invention provides a method according to the preamble that is characterized in that the donor film has a thickness of at least 0.5 micron, preferably at least 1 micron.

By providing such a relatively thick donor film the object to be marked is effectively shielded from the laser beam, thereby preventing the formation of cracks in the object to be marked and also preventing the substrate and the object to be marked from being welded together. Thus an accurate control of the gap between donor film and object is redundant.

In a particular embodiment the pulse duration of the laser beam matches the thickness of the donor film.

By providing a relatively thick donor film and matching the pulse duration of the laser beam it is possible to transfer the donor film without providing a gap between the donor film and the surface to be marked. Even without such a gap, it is prevented that the two surfaces are welded together. The invention is based on the insight that it takes a finite amount of time—a delay time—for the donor film to transfer from the substrate to the object to be marked. When the pulse duration is chosen smaller than the delay time, the donor film transfers after the laser-pulse ends. Moreover, if the layer thickness of the donor layer is larger than the thermal penetration depth, the upper part of the layer is at the melting temperature while the opposite part is still at room temperature. Thus welding is prevented.

In an advantageous embodiment the pulse duration of the laser is 20 nanoseconds or less.

As mentioned in the above, the method according to the invention offers the important advantage that no accurate control of a gap between substrate and object to be marked is needed, but that the support with the donor film can be substantially adjacent to the object to be marked. An additional advantage of the method according to the invention, where the necessity of creating a gap is prevented, is that it also can advantageously be used for marking curved surfaces. An example of such curved surface is a halogen lamp.

The present invention also relates to a marked object that is obtained by means of the above method. The marking has a thickness of at least 0.5 micron, and preferably at least 1 micron.

Although the marking method in principle can be used for marking all kinds of objects, it is in particular suitable for marking liquid crystal display panels, plasma display panels, cathode ray tubes, or constituents thereof.

The invention is further illustrated with reference to the example and the drawing in which:

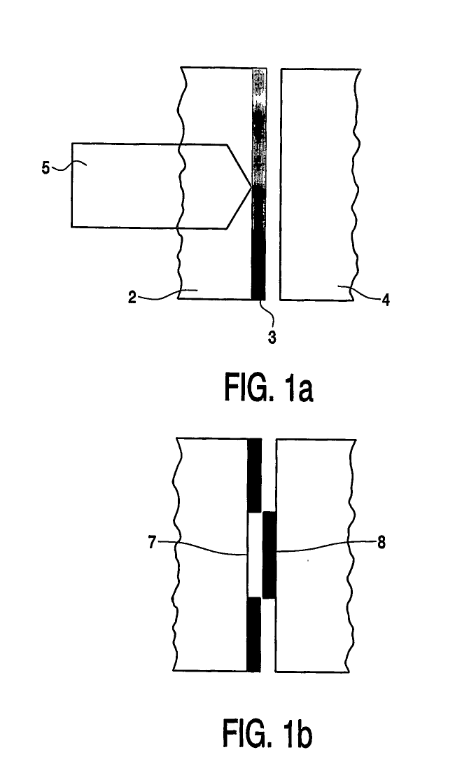

FIGS. 1a and b schematically show the principle of the LIFT method.

The drawing is purely schematic and not drawn to scale. For the sake of clarity some dimensions are exaggerated.

FIG. 1 shows a support 2 on which a donor film 3 is applied. In the present example, the support plate is a glass plate with a thickness of 1 mm. However, it is also possible to use a foil as the support, such as a thin flexible foil (e.g. 19 micron Mylar foil from Dupont). The donor film 3 may comprise any material that evaporates or sublimes upon heating by laser beam irradiation. It is generally a material used by thin film forming techniques such as vacuum evaporation coating and sputtering. For marking purposes, the material is preferably not transparent. Typical examples of donor films are chromium, aluminium, tantalum, and alloys of nickel and copper. In the present example, the support 2 is coated with a chromium layer having a thickness of 1 micron. Although—for the sake of clarity—not shown in FIG. 1, the support 2 is in contact with the target—or object to be marked—4.

Reference numeral 5 represents the laser beam that comprises a pulsed Nd-YAG at 1064 nm. Also other kinds of laser beams can be used, such as diode pumped solid state lasers (Nd-YVO4 and Nd-YAG) with pulse durations of less than 20 nsec, operating at first (1064 nm), second (532 nm), third (355 nm) and fourth (266 nm) harmonic emission. Another possibility is an excimer laser with pulse durations of less than 20 nsec, operating at 351 nm, 308 nm and 248 nm.

As shown in FIG. 1a, the laser beam 5 irradiates the donor film 3 through the support 2. According to the method of the present invention the pulse duration of the laser beam matches the thickness of the donor film, and in this case is 20 nanoseconds or less. By subjecting the donor film to such pulsated laser radiation, the laser pulse melts and partly evaporates the donor film. The evaporation pressure propels the molten film towards the target. The printed pattern 8 consists of resolidified droplets and condensed vapor. FIG. 1b shows the ablated area 7 as well as the printed pattern 8. The relatively high thickness of the donor film 3 prevents the substrate 2 from being welded to the target 4 and shields the target 4 from the laser beam 5, thereby preventing the formation of cracks. In other words, the laser irradiation is blocked by the donor film 3, which as a result acts as a shield for the target 4.

1. A method of marking an object by means of a laser beam, said method comprising the steps of:
applying a donor film (3) on a support (2), said support (2) at least partly being transparent to the laser beam;
placing the support (2) with the donor film (3) in proximity to the surface to be patterned, such that the donor film faces the object (4) to be marked;
irradiating the donor film (3) with the laser beam (5) through the support (2), thereby transcribing a pattern (8) of the donor film to the object (4); and
removing the support with the donor film from the object, characterized in that the donor film (3) has a thickness of at least 0.5 micron.

2. Method according to claim 1, characterized in that the donor film (3) has a thickness of at least 1 micron.

3. Method according to claim 1, characterized in that the pulse duration of the laser beam (5) matches the thickness of the donor film layer.

4. Method according to claim 3, characterized in that the pulse duration of the laser is 20 nanoseconds or less.

5. Method according to claim 1, characterized in that the support (2) with the donor film (3) is substantially adjacent to the object (4) to be marked.

6. A marked object, obtained by means of the method according to claim 1, characterized in that the marking has a thickness of at least 0.5 micron.

7. Marked object according to claim 6, characterized in that the marking has a thickness of at least 1 micron.

8. Marked object according to claim 6, characterized in that it comprises a liquid crystal display panel, a plasma display panel or a cathode ray tube or constituents thereof.
